(19) United States
(12) Patent Application Publication
(10) Pub. No.: US 2022/0282343 A1
(43) Pub. Date: Sep. 8, 2022

(54) PROCESS FOR MANUFACTURING RECONSTITUTED LEATHER PRODUCT

(71) Applicant: Omnia Advanced Materials LLC, Beaver Falls, NY (US)

(72) Inventors: Scott Sauer, Beaver Falls, NY (US); Peter Gendreau, Gulford, VT (US)

(73) Assignee: Omnia Advanced Materials LLC, Beaver Falls, NY (US)

(21) Appl. No.: 17/686,058

(22) Filed: Mar. 3, 2022

Related U.S. Application Data
(60) Provisional application No. 63/156,892, filed on Mar. 4, 2021.

(51) Int. Cl. C14B 1/34; C14B 1/58

(52) U.S. Cl. CPC C14B 1/34; C14B 1/58

(57) ABSTRACT

A reconstituted-leather-manufacturing process includes a progressively increasing application of pressure to an aqueous leather solution to form a web of leather fibers. The solution/web may be dewatered to an extent before the first application of a pressure so that the solution/web consistency is on the order 29-55% (fiber to web/solution, by weight) when the first pressure of the progressive sequence of pressures is applied. Tannin (and various chemicals) may be added to the solution. The progressive pressing of the solution/web may be followed by a progressive drying of the web by application of a sequence of increasing temperatures via drying vessels.

### CROSS-REFERENCE TO RELATED APPLICATIONS

This application claims the benefit of U.S. Provisional Application No. 63/156,892, filed on Mar. 4, 2021.

### BACKGROUND AND SUMMARY

This invention pertains generally to technology for manufacturing reconstituted leather product starting with a leather-fiber slurry.

The invention more specifically pertains to a novel wet pressing process to enhance leather substrate properties by increasing the internal leather fiber wet web matrix density progressively. This may be accomplished by passing the wet web through a series of nip rollers and gradually increasing the applied nip pressures to the leather substrate. The process may use primary and secondary press loading stations with the second stage utilizing both felted and unfelted soft nip press rolls.

As a result, the invention may be utilized to increase the average leather matrix strength properties and manufacture a product that can be produced in rolls or sheets. Additionally, the invention may be used to produce a leather web that has a smoother finish with lower overall stiffness than otherwise, yielding a softer-feeling leather substrate.

In one aspect of the invention, a process for manufacturing a leather product includes sequentially exposing a leather/water slurry to first and second pressures, with the second pressure greater than the first pressure. The applications of these pressures serve to dewater the slurry and conform it to the form of a web matrix of leather fibers, with the application of the pressures yielding a web density that increases with the applied pressure. Thus, the application of the first pressure yields a web having a first density and the application of the second pressure increases the density of the web to a second density. One or more additional applications of pressure (intermediate pressing stages) may be interjected between the applications of the first and second pressures. These intermediate pressures may be applied sequentially in order of increasing pressure, each higher than the first pressure and lower than the second pressure. Through the progressive application of pressures to the leather/water mixture, the resulting leather web density may be progressively increased while avoiding ruptures in the leather that may result from dewatering at too high a rate by applying too high a pressure for the density of the web.

### BRIEF DESCRIPTION OF THE DRAWINGS

These and other features, aspects, and advantages of the present invention will become better understood with reference to the following description, appended claims, and accompanying drawings where:

FIG. 1 illustrates an exemplary machine arrangement according to an aspect of the invention.

FIG. 2 is a functional block diagram illustrating an exemplary process flow according to an aspect of the invention.

FIG. 3 illustrates another exemplary machine arrangement according to an aspect of the invention.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

A process of manufacturing a reconstituted leather product includes consolidating a wet leather substrate with a series of nip rollers to significantly increase the wet web solids. This allows significant compaction of the wet continuous web flowing through the machine resulting in a higher overall solids content entering the leather dryer stage of the machine. After the drying stage, the web can be wound into a continuous roll for further conversion steps, or it can be cut into individual sheets. (Some conversion steps, such as coating or embossing, can be accomplished in-line with the drying process.) Having higher matrix compaction also allows for lower overall thermal energy having to be applied to the wet leather substrate or matrix. Utilizing lower thermal energy in the dryer stage also helps in the preservation of the leather collagen and overall leather fiber structure to enhance overall physical strength properties.

In addition to the higher strength properties being achieved in the leather substrate by the application of progressive nip pressures to the wet fiber substrate, the leather machine also creates a leather graining effect to control the leather fiber orientation. The machine may utilize multiple rotating counter flow forming cylinders in vats filled with leather fiber slurry to create a leather graining effect.

This configuration yields a fiber substrate that has more stiffness in the Machine Direction (MD) of travel and a lower stiffness or softer feeling substrate in the Cross Machine (CD) direction (the direction perpendicular to the Machine Direction of travel). In some implementations, a counter flow system allows cylinders to rotate in the opposite direction of the flow of the entering wet leather fiber slurry. As a result, a high percentage of available wet leather fibers in the slurry become more aligned in the MD at a ratio greater than 1:2 (CD:MD). In general, higher ratios of fibers oriented in the MD provide produce a stiffer end product in the MD. Likewise, a higher ratio of leather fiber orientation in the MD will also yield lower stiffness or create a softer product in the Cross Direction (CD). As a result, higher leather fiber orientation will produce higher leather graining effects in the end product.

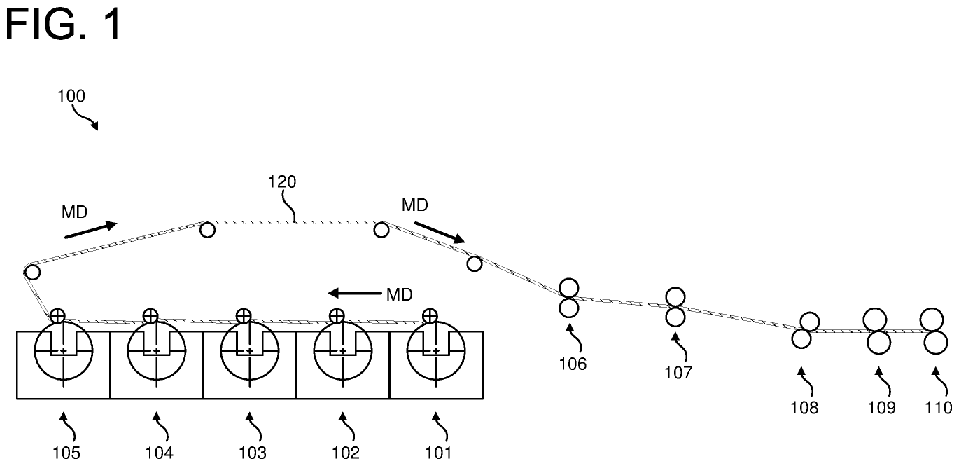

Progressive wet pressing: With reference to FIG. 1, an exemplary leather manufacturing machine 100 configuration and process is described. The machine 100 includes: (1) five vacuum assisted cylinder vats 101, 102, 103, 104, 105; (2) two double felted pneumatically loaded presses 106, 107; (3) a double felted pneumatically loaded suction couch press 108; (4) a single felted pneumatically loaded press 109; and (5) an unfelted pneumatically loaded press 110.

The wet web 120 undergoes gradual forming through water removal with vacuum cylinders and low mechanical pressure couches using the vacuum assisted cylinder vats 101-105. At these stages, liquid stock is introduced and the dewatering process begins. (Typically, the wet web 120 is supported by a felt, not shown, at some stages of the process.)

Intermediate pressure is then applied to the web 120, augmented by double felting and suction, for further wet-web bonding and water removal using the double felted presses 106-108. This results in an apparent web density of 9.5 to 11.8 pounds/mil (mass/thickness for 3000 sq. ft of material) and solids ranging from 29%-38% (by weight).

The web 120 is now dry enough that significant pressure can be applied using the single felted press 109. This can be done without exceeding the diffusion rate of water from the wet leather substrate, thereby avoiding ruptures within and on the surface of the wet leather substrate. This serves to remove water, increase web density, and smooth the surface of the web. Additional densification is applied to the wet web 120 in a soft nip roll press 109 at greater than 600 pli. The nip is felted, allowing a wider contact area and void volume for the removal of additional water and air between the fibers of the web. The web leaves this press at an apparent density between 11.5 to 11.9 pounds/mil (mass/thickness) and 30%-45% solids (by weight).

The unfelted soft nip roll press 110 completes the fiber matrix consolidation and smooths the surface of the web 120. The press 110 is loaded greater than 650 pli (pound force/linear inch). This further increases web density and smooths the web surface.

The aforementioned steps allow final drying to be completed at much lower temperatures, maintaining the integrity of the strength properties developed in the wet phase.

The following table shows an exemplary relationship between apparent web density vs the pressure application:

| | wet substrate apparent | pressure under roller |
|---|---|---|
| | density (pounds of | nip point (pounds of |
| | mass/thickness in mil for | force/linear inch |
| stage/press | 3000 sq. ft. of material) | across the nip roller) |
| 101 | 9.2 to 9.5 | 15 to 20 |
| 102 | 9.2 to 9.5 | 15 to 20 |
| 103 | 9.3 to 9.6 | 20 to 25 |
| 104 | 9.3 to 9.6 | 20 to 25 |
| 105 | 9.4 to 9.7 | 25 to 30 |
| 106 | 9.5 to 9.9 | 55 to 60 |
| 107 | 10 to 10.4 | 60 to 65 |
| 108 | 11 to 11.4 | 100 to 105 |
| 109 | 11.5 to 11.9 | 600 to 800 |
| 110 | 11.8 to 12.5 | 650 to 900 |

Summary of physical improvements: Edge Tear—ASTM 3311-1 test method: Both the Cross Direction (CD) and Machine Directions (MD) have been tested. The Cross Direction (CD) has been increased from a range of 15-21 N/mm to a Tear strength greater than 25 N/mm. The Machine Direction (MD) has been increased from a range of 11 to 15 N/mm to 16 to 20 N/mm.

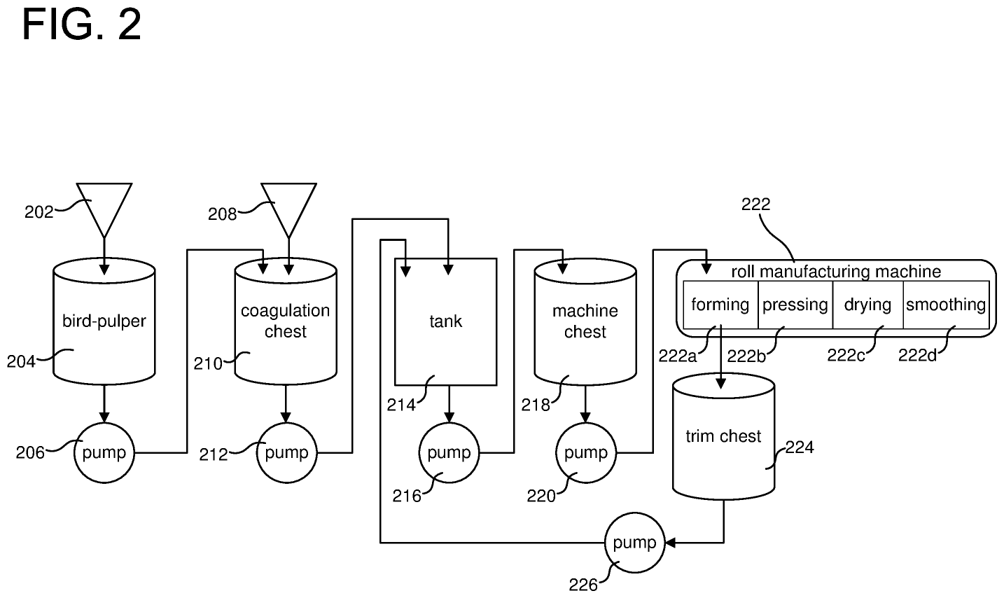

An exemplary process for manufacturing reconstituted leather product may be understood with reference to FIG. 2. In a first step, ingredients 202 are mixed and pulped in a bird-pulper 204. For example, water, leather, and various chemical additives may be blended in the pulper 204. The resultant slurry is pumped (via pump 206) to a coagulation chest 210 where more ingredients 208 (e.g., water and chemical additives) may be added and the slurry coagulated to a degree. The resultant slurry is pumped (via pump 212) to a holding/mixing tank 214 and from there (via pump 216) to a machine chest 218. The slurry is then provided (via pump 220) to a roll manufacturing machine 222 where the slurry is formed into a wet web and ultimately into the leather product as described with reference to FIG. 1. The roll manufacturing machine 222 may include forming 222a, pressing 222b, drying 222c, and smoothing 222d machine stages/sections. Unused material from the forming section 222a may be collected in a trim chest 224 and reinjected in the line through pump 226.

Tannin: Additional strength properties can be achieved in forming the leather substrate by the addition of hardwood tannin to the formulation at a rate between 1% and 10% (by weight); the addition of tannin to the slurry, gradual water removal by the continuous escalation of pressing pressure, and lower drying temperatures may be employed to improve strength results. Tannin is added to the leather mixture before the forming section on the leather machine. In conjunction with other ingredients, tannin promotes and enhances the natural binding of the fiber matrix.

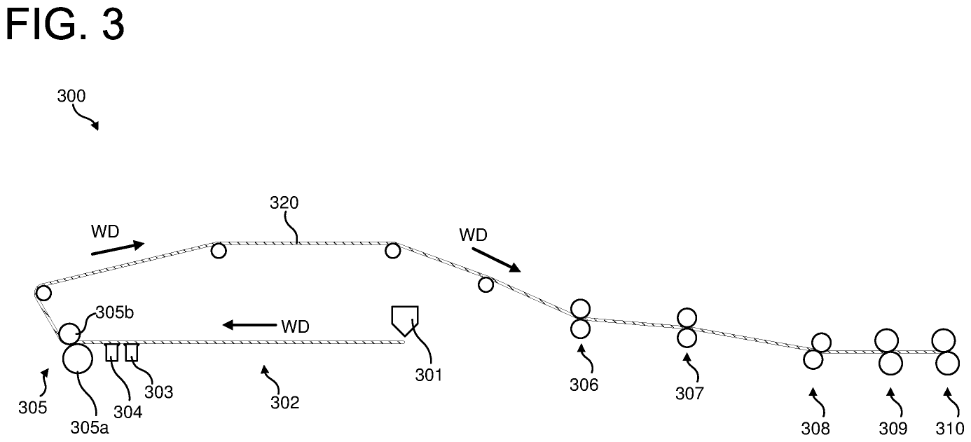

Progressive wet pressing: With reference to FIG. 3, another exemplary leather manufacturing machine 300 configuration and process is described. The machine 300 includes: (1) a Fourdrinier having a headbox 301, a forming section 302, suction boxes 303, 304, and a suction couch roll 305a (which forms part of a press 305); (2) two double felted pneumatically loaded presses 306, 307 (which may be excluded in some configurations); (3) a double felted pneumatically loaded suction couch press 308; (4) a single felted pneumatically loaded press 309; and (5) an unfelted pneumatically loaded press 310.

The wet web 320 undergoes gradual forming through provision of the slurry of leather fibers/water from the headbox 301 onto a wire mesh (not shown). The web 320 (supported by the wire mesh) moves through the forming section 302 allowing water to drain from the web 320 while retaining leather fibers in the web 320. (The rate of water drainage may be controlled through use of a forming board placed beneath the web 320.) The web 320 is then further dewatered using one or more suction boxes 303, 304. Typically, the suction boxes 303, 304 increase in pressure with distance from the head 301.

The suction couch roll/press 305 is used to further dewater the web 320. The suction couch roll/press 305 includes a nip point defined by the suction couch roll 305a and a top felted press 305b at which point pressure is applied to the web 320. (At this point, the web 320 may be transferred from the supporting wire mesh to a supporting felt.)

Intermediate pressure is then applied to the web 320, augmented by double felting and suction, for further wet-web bonding and water removal using the double felted presses 306-308. In some configurations one or more of these presses 306-308 may be unnecessary, depending on the consistency of the web 320 after pressing by the suction couch roll/press 305. (Consistency here refers to the amount of leather fiber to web/solution, by weight. Higher consistency indicates a drier web.) For example, the forming section 302 and suction box(es) 303, 304 may be configured to yield a web consistency on the order of 29%-55% fiber by weight at the entry point to the suction couch roll/press 305. For such a configuration, the pressure applied by the suction couch roll/press 305 may be of such magnitude that the progressive application of pressure to form the product may be achieved with fewer presses.

Intermediate pressure is then applied to the web 320, augmented by double felting and suction, for further wet-web bonding and water removal using the double felted presses 306-308. This can be used to increase the web consistency to the order of 32%-55%.

The web 320 is now dry enough that significant pressure can be applied using the single felted press 309. This can be done without exceeding the diffusion rate of water from the wet leather substrate, thereby avoiding ruptures within and on the surface of the wet leather substrate. This serves to remove water, increase web density, and smooth the surface of the web. Additional densification is applied to the wet web 320 in a soft nip roll press 309 at greater than 600 pli. The nip is felted, allowing a wider contact area and void volume for the removal of additional water and air between the fibers of the web. The web may leave this press with consistency approaching 60%.

The unfelted soft nip roll press 310 completes the fiber matrix consolidation and smooths the surface of the web 320. The press 310 is loaded greater than 650 pli (pound force/linear inch). This further increases web density and smooths the web surface.

The following table shows two exemplary web-consistency settings for a machine configuration that omits two intermediate presses 306, 307:

| | |
|---|---|
| Setting 1 | Setting 2 |

| | web consistency | | web consistency |
|---|---|---|---|
| stage/press | (% by weight) | stage/press | (% by weight) |
| 301 | 0.8-1.2% | 301 | 0.8-1.2% |
| 305 | 29-38% | 305 | 50-55% |
| 308 | 32-40% | 308 | 53-55% |
| 309 | 36-45% | 309 | 56-60% |
| 310 | 38-45% | 310 | ≥60% |

The last pressing stage in the line (e.g., 310 in machine 300, 110 in machine 100) may be followed by a dryer machine section (e.g., 222c in FIG. 2). The dryer may include several large rotating, felted steel dryer vessels with zone-controlled temperature settings enclosed in an air-balanced heated hood. In addition, several dryer vessels may be configured to be individually controlled to achieve precise temperature settings. The purpose of the precise temperature settings and dryer felts is to gradually modulate the bonding within the leather matrix to optimize the overall strength properties of the final product. This can be accomplished, for example, by using multiple dryer vessels in sequence, each vessel in the sequence set at a higher temperature than the previous vessel in the sequence.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A process for manufacturing a reconstituted leather product from a slurry of leather fibers in a liquid, the process including the following steps:
(a) applying a first pressure to the slurry to conform the slurry to the form of a first web matrix;
(b) then applying a second pressure to the first web matrix to conform the first web matrix to the form of a second web matrix, wherein the second pressure is greater than the first pressure.

2. The process of claim 1 further comprising applying at least one intermediate pressure after applying the first pressure and before applying the second pressure.

3. The process of claim 1 wherein:
(a) the first pressure is in the range of 15 to 20 pounds/linear inch;
(b) the second pressure is in the range of 650 to 900 pounds/linear inch.

4. The process of claim 2 wherein the at least one intermediate pressure is in the range of 16 to 800 pounds/linear inch.

5. The process of claim 2 wherein more than one intermediate pressure is applied in a sequential order, wherein each pressure of the sequence is greater than the pressure before it.

6. The process of claim 1 wherein:
(a) the first pressure is sufficient to provide the first web matrix with an apparent density of 9.2 to 9.5 pounds/mil; and
(b) the second pressure is sufficient to provide the second web matrix with an apparent density of 11.8 and 12.5 pounds/mil.

7. The process of claim 1 wherein the slurry includes a tannin.

8. The process of claim 1 further comprising adding a tannin to the slurry.

9. The process of claim 8 wherein the tannin is added to the slurry in the amount of 1-10% by weight.

10. The process of claim 1 further comprising:
(a) dewatering the slurry before applying pressure to the slurry; and
(b) wherein the first pressure is in the range of 60 to 65 pounds/linear inch and the second pressure is in the range of 650 to 900 pounds/linear inch.

11. The process of claim 1 further comprising:
(a) dewatering the slurry before applying pressure to the slurry; and
(b) wherein the first pressure is sufficient to provide the first web matrix with an apparent density of 10 to 10.4 pounds/mil; and the second pressure is sufficient to provide the second web matrix with an apparent density of 11.8 and 12.5 pounds/mil.

12. The process of claim 1 further comprising dewatering the slurry to a consistency of 29 to 55% before applying pressure to the slurry.

13. The process of claim 12 further comprising dewatering the slurry to a consistency of 50 to 55% before applying pressure to the slurry.

14. The process of claim 12 further comprising dewatering the slurry to a consistency of 29 to 38% before applying pressure to the slurry.

15. The process of claim 1 further comprising:
(a) exposing the second web matrix to a first dryer vessel at a first temperature; and
(b) then exposing the second web matrix to a second dryer vessel at a second temperature, wherein the second temperature is higher than the first temperature.

16. A process for manufacturing a reconstituted leather product from a slurry of leather fibers in a liquid using a multi-stage roll manufacturing machine having at least a first, second, and third pressing stage, the process including the following steps:
(a) applying a first pressure to the slurry at the first pressing stage to yield a first material;
(b) applying a second pressure to the first material at the second pressing stage to yield a second material, wherein the second pressure is greater than the first pressure; and
(c) applying a third pressure to the second material at the third pressing stage, wherein the third pressure is greater than the second pressure.
